(19) United States
(12) Patent Application Publication
(10) Pub. No.: US 2008/0118340 A1
(43) Pub. Date: May 22, 2008

(54) Method for Palletizing Bottles with Interleaving of Layers

(75) Inventor: Gilles Baumstimler, Octeville Sur Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, Octeville Sur Mer (FR)

(21) Appl. No.: 11/665,804

(22) PCT Filed: Oct. 19, 2005
(86) PCT No.: PCT/FR05/02587

§ 371 Date: Apr. 19, 2007

(30) Foreign Application Priority Data
Oct. 20, 2004 (FR) 0411135

(51) Int. Cl. B65G 57/24

(52) U.S. Cl. 414/799; 901/31

(57) ABSTRACT

A palletizing method which includes: preparing a template capable of receiving a batch of bottles and of positioning the different bottles of the batch according to a distribution scheme adapted to the bottle to be palletized; picking a batch of bottles at the loading station, where the bottles are arranged in close succession, organized in a square, by means of a maneuvering tool including pneumatic gripping bell-shaped heads whereof the inside diameter is considerably larger than of the necks of the bottles on the template; deactivating the gripping heads to release the bottles which are automatically wedged on the template and to be able to release the maneuvering tool; pressing an inter-layer sheet on the necks of the bottles wedged on the template; repositioning the maneuvering tool on the wedged bottles and reactivating the gripping heads; removing with the maneuvering tool the batch of bottles recently wedged with its inter-layer sheet for transferring and setting the whole assembly onto one pallet or another; then starting over again the process by picking another batch of bottles to set in onto the template, fitting in an inter-layer sheet then picking up again the batch and setting it on the inter-layer sheet of the first layer and so on until the expected number of layers is obtained.

The present invention relates to a method of palletizing bottles arranged in a square, in a vertical position, with the interleaving of layers and the insertion of interlayer sheets. It also relates to the means and the installation for implementing this method.

The bottles may be palletized in a vertical position in various ways. The method of palletizing bottles arranged in a square, with the various layers interleaved, for example, allows a substantial increase in the extent to which a container, of whatever kind—pallet, crate, box, etc.—can be filled.

This square layout can be established right from the start of the palletizing operation, that is to say at the pick-up station, where the bottles are stored in one or more rows, touching one another within each row, before being picked up by the handling tool.

During palletization, the bottles are interleaved over a height which corresponds to the height of the necks of the bottles. The first layer is, for example, set down directly on the palette and the others are set down on a kind of perforated floor which slips over the necks of the bottles and rests on the shoulders thereof, which floor constitutes that which, in the remainder of the text, will be termed the interlayer sheet.

This interlayer sheet, which can be found in documents U.S. Pat. No. 5,263,605 and GB 1347005, for example, may be in the form of a simple plate or, as appropriate, in the form of a tray to envelope and restrain the side bottles.

This palletization method is used especially for bottles whose shoulder between the linerel and the neck is broad enough to accept and immobilize the interlayer sheet, that is to say bottles the shape of which can be likened to that of a Bordeaux wine bottle.

The function of the interlayer sheet is also to wedge the bottles of one and the same layer relative to one another; it establishes an appropriate layout pattern for the mutual layout of the bottles of one and the same layer, allowing sufficient space to be left for the linerels of the bottles of the layer above, so that these can fit in between the necks of the bottles already wedged and installed in the pallet or the like.

However, the pattern in which the batch of bottles is laid out, when the bottles are at the pick-up station, does not have the same characteristics as the layout pattern dictated by the interlayer sheet, that is to say the pattern intended for palletizing the bottles.

Specifically, at the pick-up station, the bottles are touching one another whereas, on the storage pallet or the like, they are slightly spaced apart.

This difference between the two layout patterns stems from the way in which bottles are palletized: the bottles being arranged in a square in each layer with the various layers of bottles interleaved.

When the bottles are arranged in a square, the central space between four adjacent necks may, depending on the shape and size of the bottles, allow the linerel of a bottle to be nested in between said four necks. However, in order to be able to do this, there is a certain relationship between the diameter of the linerel of the bottle and the diameter of the neck that has to be observed: the diameter of the necks has to be less than 0.414×D where D is the diameter of the linerels of the bottles.

This relationship does not hold true of certain types of bottle and, in particular, in the case of bottles with a capacity of less than one liter, but the benefit of interleaved palletization is such that by forcing the issue a little, and by using an interlayer sheet, it is often possible to slightly alter the inter-axis distance between these bottles on the pallet and interleave the various layers of bottles with one another.

As a result of this, the pattern in which the bottles are laid out at the pick-up station where they are touching one another differs from the layout pattern of these same bottles at the palletization station. At this palletization station, the bottles in each column and each row are spaced slightly apart; their inter-axis distance is slightly greater than the diameter of the linerels, that is to say slightly greater than it is at the pick-up station.

This difference in inter-axis distance at the start and at the end of the palletization process causes incidents such as, for example, causing the bottoms of the incoming bottles to knock against the neck ends or, as the case may be, the closures of the bottles already in place.

These knocks may cause damage to the neck ends and, in the case of full bottles, to the closures. In the case of capped bottles, for example, the damage may affect both the esthetic appearance of the cap and its sealing. The consequence of this sealing problem is that the product sooner or later becomes contaminated.

In order to remedy this problem, the invention proposes an improvement to the palletization operating process performed currently, for example the one described in document FR 2593776.

In the context of this process, the invention proposes means which, while using current bottle-handling tools, make it possible to obtain incomparable results by virtue, in particular, of greater precision in the positioning of the bottles relative to one another and, above all, while they are being transported and positioned, by holding said bottles effectively.

Implementation of the method according to the invention and of the means associated with this method afford results which allow bottle damage and, in particular, damage to the closure and/or sealing system of the bottles to be avoided.

The tools conventionally used for handling the bottles, throughout the palletization process, comprise a multitude of gripper heads and these gripper heads are arranged on lines which are aligned beside one another, mutually parallel. Each line comprises a row of heads, the mutual inter-axis distances of which are constant; these heads practically touch one another on these lines.

These lines are secured to the overall frame structure of the handling tool, by way of slideways, which allows their spacing to be adjusted as a whole and on demand, while at the same time keeping them mutually parallel, and therefore allows the inter-axis distance of the heads to be varied in a direction perpendicular to said lines.

The inter-axis distance of the transverse rows of bottles can be adjusted in one direction, transversely with respect to the lines and to the rows of heads of fixed inter-axis distance, by means of the handling tool; by contrast, on the lines themselves, the heads are fixed, and their inter-axis distances invariable.

When the number of bottles picked up by each line is less than or equal to a maximum of six, the spatial offset between the linerels of the incoming bottles with respect to the necks of the bottles already palletized is relatively small, that is to say that the batch of bottles carried by the handling tool can be interleaved with the batch of bottles already in place without any risk of significant damage.

Over and above six bottles, the offset between the length of a row of bottles touching one another, carried by the line, and the length of a row of palletized bottles is too great, and incidents are unavoidable.

The method according to the invention allows better control, throughout the palletization operating process, of the respective position of the various bottles on each line and, in particular, allows an inter-axis distance-between the bottles of each line to be established that corresponds to the distance it needs to be in order to palletize them in complete safety, particularly when the number of bottles per line ranges between 6 and 12, for example.

According to the invention, the method of palletizing with the interleaving of layers consists:
in preparing a template able to accept a batch of bottles originating, for example, from a pick-up station, said template being designed to accept and position the various bottles in a layout pattern suited to the type of bottles being palletized and which corresponds to that of the palletization pattern;
in taking a batch of bottles from said pick-up station, where the bottles are touching one another, laid out ready in a square, using a handling tool comprising appropriate gripper heads and, in particular, heads the internal diameter of which is markedly greater than that of the neck ends of said bottles;
in offering said batch of bottles up to said template and setting it down thereon;
in deactivating said gripper heads to release and drop the bottles which automatically wedge themselves on said template and in order to be able to disengage said handling tool;
in pushing an interlayer sheet over the necks of the bottles wedged by said template;
in repositioning the tool over said wedged bottles and in reactivating the gripper heads;
in picking up the batch of bottles newly wedged by said template, with its interlayer sheet, and in transferring the entirety to the setting-down station comprising, for example, a pallet or the like,
in setting said batch of wedged bottles down on the pallet or the like, and in deactivating said gripper heads to release said bottles and move said handling tool away; then,
in repeating the abovementioned process by picking up another batch of bottles from the pick-up station to offer it up to and set it down on said template, in installing the interlayer sheet then in picking said batch back up and setting it down on the interlayer sheet of the previous layer and so on until the desired number of layers is reached.

Offering a batch of bottles up to the template and setting it down thereon are operations which make it possible to guarantee that these bottles will be perfectly positioned for the remainder of the operations, with the correct inter-axis distance between the various bottles, that is to say with an inter-axis distance that is long enough to allow the linerels to fit in between the necks without risk of damaging these necks.

In addition, the fact of positioning the interlayer sheet over the bottles and pushing it down over their necks when they are positioned on the template guarantees that the inter-axis distance between the bottles is strictly maintained when these bottles are taken up again by the handling tool and while they are being moved around.

Gripper heads of the handling tool have the special feature that they can each adapt to the offset there might be between their axis and that of the bottle to be taken on the template, and this offset is maintained because of the presence of the interlayer sheet during transport to the palletization station. This measure makes it possible to guarantee that the bottles are perfectly perpendicular to the setting-down surface and therefore allows the bottoms of the bottles to be slipped very precisely between the neck ends and necks of the bottles already in place.

Again according to the invention, the method consists, before setting down a batch of bottles on the template, in centering said batch with respect to the geometric center of said template.

According to another provision of the invention, the method consists in installing the interlayer sheet using the handling tool, said tool being equipped for this purpose with appropriate means for, on the one hand, gripping the interlayer sheet and, on the other hand, wedging this interlayer sheet on the shoulders of the bottles in order to position it at the desired level.

Again according to the invention, the palletization method may be applied to batches comprising a significant number of bottles, in particular to batches in which the number of bottles picked up by a line in which the number of fixed-inter-axis heads exceeds 12, for example, which method, in this case, consists:
in picking up the batch of bottles en masse at the pick-up station using a handling tool comprising lines, which are made up of several sections, each section comprising about twelve gripper heads at most;
in moving said sections of said lines apart using appropriate devices, of the actuator kind, centering said sections on the geometric center of that zone of the template at which the batches of bottles carried by these various sections will be set down;
in continuing the operations detailed hereinabove in the general method, from the setting-down on the template and, finally, having set the bottles down at the palletization station, in bringing the various sections of said lines back together again before repositioning the handling tool at the pick-up station in order to pick up a further batch of bottles.

The invention also relates to the means for implementing the palletization method, which means first of all consist in a template which comprises a plate-like base and pegs laid out over said plate in a way that corresponds to the palletization pattern and to the layout of the orifices in the interlayer sheet, which base is made of a rigid material, of the aluminum type, and is equipped with pegs made of a synthetic material.

Again according to the invention, the pegs for wedging the bottles are conical in shape over all or part of their height, at least over the upper ¾ of their height, and their height is of the order of 10 cm, for example.

The invention also relates to the bottle handling tool for implementing the method, and in particular to the gripper heads of this tool, which are bell-shaped, of the pneumatically-operated type. These gripper heads have an internal diameter for accepting the neck ends of the bottles that are to be palletized that is markedly greater than the diameter of said neck ends so as to allow the axes of said bottles and the axes of said gripper heads to be mutually offset. The internal diameter of the gripper heads is of the order of 1.5 times the diameter of the neck ends of the bottles.

Again according to the invention, the handling tool comprises lines equipped with gripper heads, which lines and, in particular, the lines which bear rows of heads with fixed inter-axis distances, are divided into several sections aligned end to end, each section comprising about twelve heads at most, and these various aligned sections can move slightly relative to one another along a same longitudinal axis, propelled by appropriate devices, so as to distribute between them the difference in length there is between the length of a row of bottles arranged touching one another and the length of this same row on the template.

The handling tool according to the invention may also comprise appropriate means of the gripper or suction-cup type for placing the interlayer sheet over the batch of bottles at the wedging-on-template station and means of the press type for pushing and wedging said interlayer sheet on the shoulder of said bottles.

The invention also relates to the palletizing installation that allows implementation of the method, which installation comprises:
a pick-up station where the bottles are arranged in a square and touching one another, made ready in batches;
a palletization station, and, between these two,
a station comprising a template for distributing the bottles in a pattern which corresponds to the palletization pattern, which station lies near a zone for storing interlayer sheets,
a robot installed near the various stations, of the type having a rotary arm or of the type having a gantry with a sliding trolley, which robot is equipped with a tool which handles the bottles in the various stages of the method described hereinabove.

The invention will be further detailed with the aid of the following description and of the attached drawings, which are given by way of indication and in which:

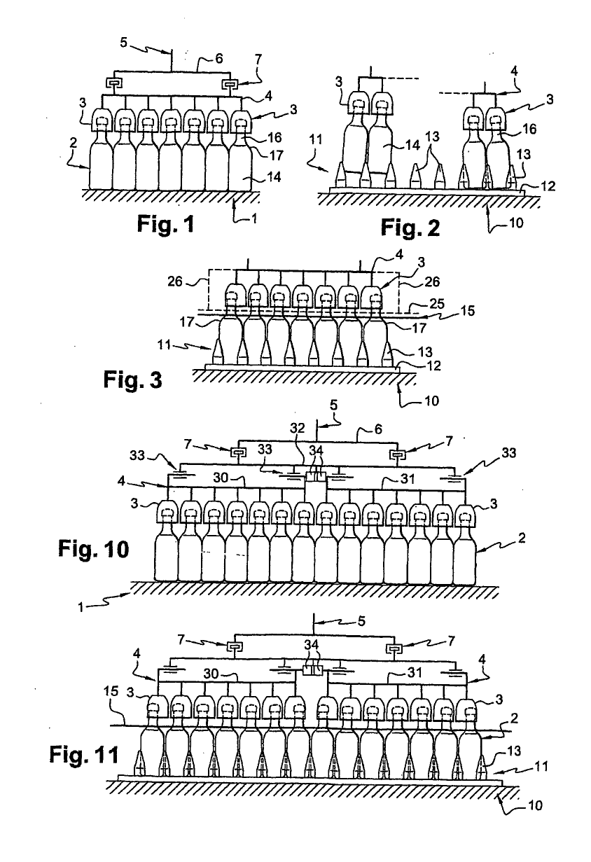

FIG. 1 is a schematic elevation of a gripper tool showing the gripper heads of the first line, which heads sit over a row of bottles touching one another, at the pick-up station;

FIG. 2 illustrates, on one side, the operation of setting these bottles down at the station comprising the template and, on the other side, their insertion between the pegs of said template using the handling tool;

FIG. 3 shows the batch being picked up again at the template station by said handling tool once the interlayer sheet has been fitted over the necks of the bottles;

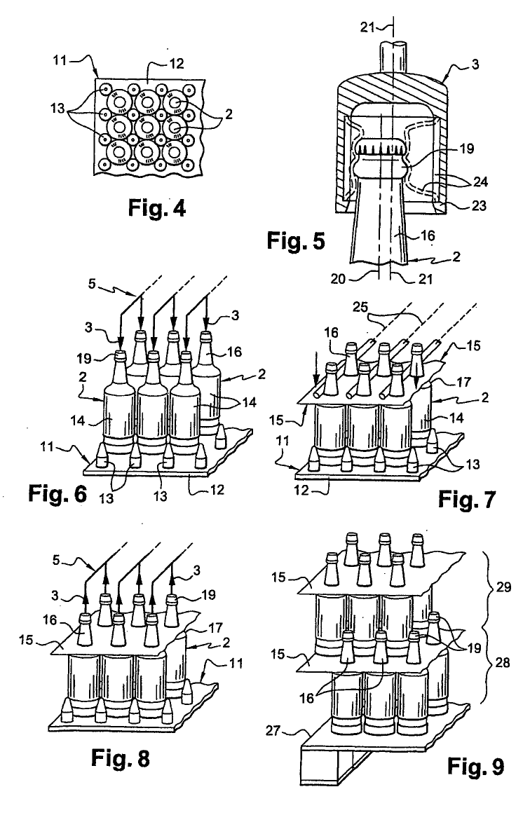

FIG. 4 shows, in a view from above, a small number of bottles wedged between the pegs of said template, which template is depicted partially;

FIG. 5 shows, in section, a bottle gripper head of the pneumatically-operated bell kind;

FIG. 6 shows, schematically and in perspective, a small batch of bottles set down on the template;

FIG. 7 shows the step of placing and wedging the interlayer sheet over the bottles positioned on the template of FIG. 6;

FIG. 8 shows the bottles from the preceding figure being picked back up again via the handling tool, with the interlayer sheet in position on said batch;

FIG. 9 shows the result of the process of palletizing two layers of bottles as prepared in FIGS. 6 to 8;

FIG. 10 depicts, like FIG. 1 but for a larger number of bottles, a gripper tool with a row of bottles, at the pick-up station;

FIG. 11 shows the insertion of the row of bottles as depicted in FIG. 10 and, in particular, the insertion of the linerels of said bottles, between the wedging pegs at the template station;

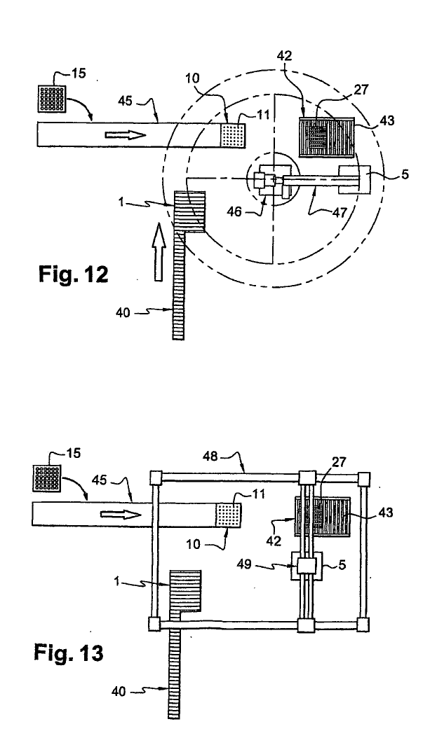

FIG. 12 shows an installation for implementing the method according to the invention, comprising a robot that has a gantry and pivoting arm;

FIG. 13 shows a variant of the installation depicted in FIG. 12.

The pick-up station (1) depicted in FIG. 1 comprises a row of bottles (2) which are touching one another. These bottles (2) are held by appropriate gripper means such as, for example, bell-shaped heads (3) of the pneumatically-operated type. These various heads (3) are arranged on a line (4) and fixed to the latter, that is to say that their inter-axis distance is constant.

The line (4), together with other lines which are not shown, forms part of the tool (5) used to handle the batches of bottles. This handling tool (5) comprises a supporting structure (6) on which other lines, not visible, are installed, via slideways (7); these other lines are arranged one beside the other and mutually parallel. Conventional means, not depicted, of the scissor-stay type, allow a uniform separation to be set between the various lines (4).

The batch of bottles (2) picked up by the handling tool (5) at the pick-up station (1) is then moved to the station (10), FIG. 2, where the bottles are set down on a template (11). This template (11), as depicted also in FIG. 4, consists of a base (12) made of a relatively rigid material of the aluminum type, and of pegs (13) made of a synthetic material. These pegs (13) are made of a material that is relatively flexible, so as to lessen and absorb knocks as the bottles (2) are being set down on the template (11); they are, for example, inserted in holes in the base (12).

The pegs (13) are arranged in a square, like the bottles, and the way in which they are laid out over the base (12) corresponds to the layout pattern for the bottles at the palletization station which will be addressed later on in conjunction with FIG. 9 in particular.

When the bottles arrive on the template (11), borne by the handling tool (5), they are laid out in a square, touching one another, and the way in which they are laid out does not correspond to that of the layout pattern dictated by the pegs (13), but said bottles automatically position themselves between said pegs (13) nonetheless, thanks to their linerel (14) which is guided by these pegs (13).

The pegs (13) are conical in shape over all or part of their height, at least over the upper ¾ of their height; their height is of the order of 10 cm, for example.

Storage of each bottle between the pegs (13) is also made easier by the fact that the various lines (4) of the handling tool (5) are centered beforehand with respect to the geometric center of the corresponding accepting rows on the template (11); as a result of this, the bottles in the middle of these rows position themselves on said template (11) without really being deflected.

The bottles are released by the gripper heads (3) as soon as they have been inserted between the pegs (13), the heads being deactivated and the handling tool (5) moves away to allow the insertion of a perforated plate or floor structure which acts as an interlayer sheet (15). This interlayer sheet (15) fits over the necks (16) of the bottles, resting on the shoulder (17) of each bottle; it in some way locks the position of the bottles relative to one another, which position is established by the template (11). The layout of the orifices in the interlayer sheet (15) is identical to that of the pegs (13) of the template (11).

The gripper heads (3) are then placed back over the bottles and reactivated, as depicted in FIG. 3, to transfer said bottles to the palletization station detailed later on but, for this operation, said gripper heads (3) of each line (4) are no longer centered relative to said bottles.

These bell-shaped gripper heads (3) have an external diameter which is at most equal to the diameter of the linerels (14) of the bottles (2).

FIG. 5 schematically illustrates a head (3) sitting over the neck end (19) of a bottle (2). The axis (20) of the bottle (2) is offset relative to the axis (21) of the head (3); the internal diameter of this head (3) is markedly greater than the diameter of the neck end (19), by a factor of about 1.5, for example.

This significant amount of clearance that the neck ends (19) enjoy inside the head (3) makes it possible, when the batch of bottles is being picked up again at the station (10) at which the bottles are wedged by the template (11), for each neck end (19) to be grasped without altering the position of the bottles which are also wedged by the interlayer sheet (15) and allows this position to be maintained throughout the time needed to move the batch of grasped bottles to the palletization station.

These bell-shaped heads (3) are of the pneumatically-operated type. They comprise a skirt (23) containing a sleeve (24) made of an elastic material of the rubber type. This sleeve (24) surrounds the neck end (19) of the bottles and its deformation by the pressure of the compressed air may be asymmetric, allowing it to tolerate an offset between the axis of said neck end (19) and the axis of the head (3).

FIGS. 6 to 9 schematically and in a simplified way illustrate details of the palletization method according to the invention.

This palletization method consists:
in preparing a template (11) able to accept a batch of bottles originating, for example, from a pick-up station, said template (11) being designed to accept and position the various bottles in the palletization pattern corresponding to the type of bottles;
in taking a batch of bottles from said pick-up station, where the bottles are touching one another, laid out ready in a square, using a handling tool (5) comprising appropriate gripper heads (3) of the pneumatically-operated bell-shaped type and, in particular, gripper heads (3) the internal diameter of which is markedly greater than that of the neck ends (19) of said bottles;
in offering said batch of bottles up to said template (11) and setting it down thereon, and in deactivating said heads (3), by releasing the pressure, to release the bottles and in order to be able to disengage said handling tool (5).

FIG. 6 illustrates these various steps showing a batch of bottles (2) which are positioned on the template (11). The various bottles are positioned and laid out on the template (11) by means of the pegs (13).

The method also consists, before setting a batch of bottles down on the template (11) as illustrated in FIG. 6, in centering said batch with respect to the geometric center of said template (11).

The bottles (2) automatically wedge themselves, as depicted in FIG. 4, between the various pegs (13) with a precise inter-axis distance which corresponds to the one they need to have for palletization.

The method next consists in fitting an interlayer sheet (15) over the necks (16) and in wedging this interlayer sheet (15) on the shoulder (17) of each bottle.

FIG. 7 illustrates this fitting of the interlayer sheet (15) which may be in the form of a flat sheet, as depicted, or in the form of a tray as appropriate, and which rests on the shoulder (17) of each bottle (2).

At this level, the bottles are perfectly wedged both on the template (11) and by the interlayer sheet (15). They are all mutually parallel, perpendicular to the base (12) of the template (11) and to the interlayer sheet (15).

The method also consists in fitting this interlayer sheet (15) using the handling tool (5). In this case, the handling tool (5) comprises appropriate means of the gripper or suction-cup type, not depicted, which allow it to be used for automatically positioning the interlayer sheet (15) over the various batches of bottles when they are in place on the template (11).

The tool may also comprise means for pushing and wedging the interlayer sheets onto or on the shoulder (17) of the bottles. These means are illustrated in FIG. 7 in the form of presses (25); these presses (25) run under the gripper heads (3), as depicted in FIG. 3, and are fixed to the line (4) by means of connecting arms, not depicted. These presses preferably consist of rods which are round so as to prevent them from catching on the caps if the bottles in question are stoppered, as the tool is withdrawn.

The method next consists in repositioning the handling tool (5) over the newly wedged bottles, as depicted in FIG. 8, and in reactivating the gripper heads (3) then picking up this batch of wedged bottles, with its interlayer sheet (15), and transferring the entirety to the palletization station. During this transfer, the offset between the inter-axis distance of the heads (3) and that of the bottles carried by said heads (3) is automatically maintained.

After this transfer operation, the method consists in setting the batch of bottles down on the pallet (27) or the like, for example, and in deactivating the gripper heads (3) by releasing the pressure to release the bottles and move the handling tool (5) away, then in repeating the abovementioned process by picking up another batch of bottles from the pick-up station to offer it up to and set it down on the template (11), in installing the interlayer sheet (15) then picking said batch back up again and setting it down on the interlayer sheet (15) of the first layer and so on until the desired number of layers is reached.

FIG. 9 illustrates this final step; it shows a pallet (27) on which several batches of bottles have been set down: a first batch (28) has first of all been set down with its interlayer sheet (15), which interlayer sheet (15) acts as a floor structure to accommodate the second batch (29) which also is brought with its interlayer sheet (15) by the handling tool (5).

The handling tool (5) picks up the batch of bottles as depicted in FIG. 8 with the bottles wedged both by the pegs of the template (11) and by the interlayer sheet (15). As a result, and thanks to the gripper heads (3), the bottles maintain their position and remain mutually parallel and perpendicular to the interlayer sheet making it possible, as shown by FIG. 9, for the incoming upper batch of bottles to be nested precisely between the necks (16) of the lower layer which is already in place. This high precision with which positioning is performed obviates the risk of the bottoms of the bottles of the incoming batch knocking against the neck ends (19) of the batch of bottles already in place.

For relatively large batches of bottles with columns each containing in excess of 12 bottles, for example, the gripper heads (3) of one and the same line (4) are no longer capable of absorbing the offsets between the length of a row of bottles positioned touching one another and the length of a row of bottles positioned on the template.

In this case, the handling tool (5) comprises lines which are duplicated, split into several sections. FIG. 10 schematically shows a handling tool (5) which comprises lines (4) split into two sections (30) and (31) for example. These sections (30) and (31) are aligned and each of them in fact corresponds to a conventional line (4) as detailed hereinabove. These sections (30) and (31) are mounted on an intermediate supporting structure (32) via guides (33) which are perpendicular to the slideways (7).

The number of sections is chosen according to the number of bottles to be handled.

At the pick-up station, as depicted in FIG. 10, the sections (30) and (31) are moved closer together to pick up the bottles which are touching one another. Next, in order to offer the bottles up to the template (11), the sections are parted from one another along the same longitudinal axis in order to manage, by distributing it, the offset that ensues from this type of palletization.

Appropriate means (34), of the actuator or similar kind, are interposed between the sections (30) and (31) and the intermediate supporting structure (32) to regulate the mutual separation of said sections.

The mutual separation of the sections (30) and (31) allows the bottles to be offered up to the template (11) with each batch of bottles precentered as depicted in FIG. 11, facing the zone where it will be accommodated on said template (11).

The separation of the sections (30) and (31) is maintained as the bottles are picked back up off the template (11) at the station (10) after the interlayer sheet (15) has been fitted, and during transport and setting-down at the palletization station.

After the bottles have been set down at the palletization station, the sections (30) and (31) are brought closer together again, and the handling tool (5) can be used to pick up another batch of bottles where the bottles are touching one another.

The method, in this case of a batch containing a significant number of bottles, consists:
in picking up the bottles (2) at the pick-up station (1) using the handling tool (5) comprising gripper heads (3) arranged in lines (4) split into several aligned sections (30) and (31);
in moving said sections (30) and (31) apart, at the same time centering each on the geometric center of that zone of the template at which the batches of bottles formed by these various sections (30) and (31) will be set down;
in continuing the operations detailed hereinabove in the general method, from the setting-down of the batches of bottles on the template (11) and, finally, having set the bottles down at the palletization station, in bringing said sections (30), (31) back together again before repositioning the handling tool (5) at the pick-up station in order to pick up a further batch of bottles.

The method detailed hereinabove and the means for implementing it can be used for all bottle-palletization work, both in the case of empty bottles and in the case of full bottles, at the end of a bottling line or alternatively in bottle reconditioning plants.

FIG. 12 shows an installation which implements the method according to the invention and FIG. 13 shows a variant embodiment.

These two palletization installations have the following in common:
a conveyor (40) which conveys the bottles for palletizing to the pick-up station (1) where they are arranged touching one another, in a square pattern;
a palletization station (42) situated at the upstream part of a conveyor (43) that removes the pallet (27) or the like when the palletization operation is complete;
a station (10) which comprises the template (11) on which the bottles are set out with the required spacing, which station (10) lies downstream of a zone for storing the interlayer sheets (15) or of a conveyor (45) conveying these interlayer sheets (15); and these two palletization installations differ in terms of the robot used to handle and move the batches of bottles and any interlayer sheets (15).

In FIG. 12, the robot (46) comprises an arm (47) which can move about a vertical axis. This rotary arm (47) bears, at its end, a handling tool (5) and this handling tool (5) picks up and sets down the batches of bottles, in the conventional way, at the pick-up station (1), at the station (10) where the template is located, and finally at the palletization station (42), respectively.

The special feature of this installation is that the station (10) is inserted between the pick-up station (1) and the palletization station (42) for wedging the bottles on the template (11) in the palletization pattern that suits said bottles.

In FIG. 13, the robot (46) comprises a gantry (48) which is of the type that has a sliding trolley. This trolley (49) bears the gripper tool (5) and the latter moves the batches of bottles from station to station, as before, and moves the interlayer sheets, as the case may be.

Thus, the gripper tool (5) picks up a batch of bottles at the pick-up station (1) and conveys it onto the template (11) at the station (10). At this station (10) the interlayer sheet (15) is positioned on the bottles either by hand or using the handling tool (5), and the entity is picked back up again by said tool (5) to be transferred to the palletization station (42).

The method detailed hereinabove and the means for implementing it can be applied without restriction to the palletization of any kind of object, container or other, the shape of which allows interleaving and the insertion of an interlayer sheet.

1. A method of palletizing bottles arranged in a square, in a vertical position, with the interleaving of layers and the insertion of interlayer sheets, which method comprises:
in taking a batch of bottles from said pick-up station, where the bottles are touching one another, laid out ready in a square, using a handling tool comprising gripper heads the internal diameter of which is markedly greater than that of the neck ends of said bottles;
in offering said batch of bottles up to said template and setting it down thereon positioned between said pick-up station and said palletization station, which template is designed to accept and position the various bottles in a layout pattern suited to the type of bottles being palletized;
in releasing the pressure in said gripper heads to release the bottles which automatically wedge themselves on said template and in order to be able to disengage said handling tool;
in pushing an interlayer sheet over the necks of the wedged bottles;
in repositioning the handling tool over said bottles which are wedged both by said template and said interlayer sheet and in reestablishing the pressure in the gripper heads which adapt themselves to the position of said wedged bottles;
in picking up the batch of newly wedged bottles and in transferring this batch, together with the interlayer sheet, to the palletization station comprising a pallet or the like;
in setting said batch of wedged bottles down on the pallet or the like, and in releasing the pressure in said gripper heads to release said bottles and move said handling tool away; then,
in repeating the abovementioned process by picking up another batch of bottles from the pick-up station to offer it up to and set it down on said template, in installing the interlayer sheet then in picking said batch back up and setting it down on the interlayer sheet of the first layer and so on until the desired number of layers is reached.

2. The method of palletizing bottles as claimed in claim 1, wherein it consists, before setting down a batch of bottles at the station comprising the template, in centering said batch with respect to the geometric center of said template.

3. The method of palletizing bottles as claimed in claim 1, wherein it consists in installing the interlayer sheet using the handling tool, which tool is equipped for this purpose with appropriate means for, on the one hand, gripping the interlayer sheet and, on the other hand, wedging this interlayer sheet on the shoulders of said bottles.

4. The method of palletizing batches of bottles comprising a significant number of bottles per batch, and in particular batches in which the number of bottles per row exceeds 12, for example, which method, according to claim 1, consists:
in picking up the batch of bottles en masse at the pick-up station using a handling tool comprising lines equipped with gripper heads with fixed mutual separation, which lines are made up of several sections, each section comprising about twelve gripper heads at most;
in moving said sections apart using appropriate devices, centering each on the geometric center of that zone of the template at which the batches of bottles carried by these various sections will be set down;
in continuing the operations detailed hereinabove in the general method as claimed in claim 1, from the setting-down of the bottles on the template and, finally, having set the bottles down at the palletization station, in bringing the various sections back together again before repositioning the handling tool at the pick-up station in order to pick up a further batch of bottles.

5. A template for implementing the palletization method as claimed in claim 1, wherein it comprises a plate-like base and pegs laid out over said base in a way that corresponds to the palletization pattern, which base is made of a rigid material, of the aluminum type, and is equipped with means for housing and securing said pegs which are made of a synthetic material.

6. The template as claimed in claim 5, wherein the base has pegs which are conical in shape over all or part of their height, at least over the upper ¾ of their height, which height is of the order of ten centimeters.

7. A bottle-handling tool for implementing the palletization method as claimed in claim 1, wherein it comprises bell-shaped gripper heads of the pneumatically-operated type, which gripper heads have an internal diameter markedly greater than the diameter of the neck ends of said bottles, of the order of 1.5 times this diameter, so as to allow the axes of said bottles and the axes of said gripper heads to be mutually offset.

8. The bottle-handling tool as claimed in claim 7, wherein it comprises lines equipped with gripper heads, which lines are divided into several sections aligned end to end, each section comprising about twelve heads at most, and these various sections can move slightly relative to one another along a same longitudinal axis, propelled by appropriate devices, so as to distribute between them the difference in length there is between the length of a row of bottles arranged touching one another and the length of this same row on the template.

9. The bottle-handling tool as claimed in claim 7, wherein it comprises, on the lines, appropriate means of the gripper or suction-cup type for placing the interlayer sheet over the batch of bottles at the station and means of the press type for pushing and wedging said interlayer sheet on the shoulder of said bottles.

10. An installation for palletizing bottles arranged in a square, in a vertical position, with the interleaving of layers and the insertion of interlayer sheets, for implementing the method as claimed in claim 1, wherein it comprises:
a pick-up station where the bottles are arranged in a square and touching one another, made ready in batches;
a palletization station, and, between these two,
an intermediate station which comprises a template, on which the bottles are set out with the required spacing, which station lies downstream of a zone for storing the interlayer sheets or of a conveyor conveying these interlayer sheets;
a robot of the type having a rotary arm or of the type having a gantry with a sliding trolley, which robot is equipped with a handling tool.
